(19) United States
(12) Patent Application Publication
(10) Pub. No.: US 2020/0385298 A1
(43) Pub. Date: Dec. 10, 2020

(54) METHOD FOR RETAINING AMMONIA NITROGEN AND REMOVING ANTIBIOTICS IN BIOLOGICAL TREATMENT OF LIVESTOCK WASTEWATER

(71) Applicants: EAST CHINA UNIVERSITY OF SCIENCE AND TECHNOLOGY, Shanghai (CN); SHANGHAI INSTITUTES FOR ENVIROMENTAL SCIENCES, Shanghai (CN)

(72) Inventors: Guomin Cao, Shanghai (CN); Linyan Yang, Shanghai (CN); Yongdi Liu, Shanghai (CN); Xianbo Sun, Shanghai (CN); Weibo Xue, Shanghai (CN); Kai Li, Shanghai (CN); Yejin Li, Shanghai (CN); Genxiang Shen, Shanghai (CN)

(21) Appl. No.: 16/882,802

(22) Filed: May 26, 2020

(30) Foreign Application Priority Data
Jun. 5, 2019 (CN) 201910485522.8

(51) Int. Cl. C02F 3/12; C02F 3/28; C02F 3/34

(52) U.S. Cl. CPC C02F 3/1205; C02F 2103/20; C02F 3/34; C02F 3/2846

(57) ABSTRACT

A method for retaining ammonia nitrogen and removing antibiotics in biological treatment of livestock wastewater is provided. A nitrification inhibitor is added into an aerobic bioreactor with a sludge age greater than or equal to 30 days to inhibit the activity of nitrifying bacteria. The nitrification inhibitor is preferably 2-chloro-6-(trichloromethyl)pyridine or allylthiourea. By adding a chemical agent capable of inhibiting the activity of nitrifying bacteria into the aerobic biological treatment unit for treating livestock and poultry farming wastewater, the occurrence of ammonia nitrogen nitrification is inhibited without sacrificing the degradation of COD and antibiotics by heterotrophic bacteria, so that the aims of retaining ammonia nitrogen while removing antibiotics are realized.

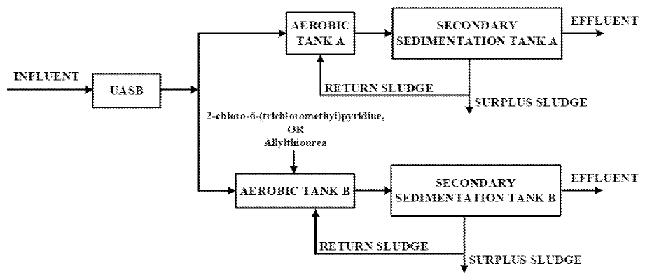

### CROSS REFERENCE

The application claims the priority of Chinese Patent Application No. 201910485522.8, entitled “METHOD FOR RETAINING AMMONIA NITROGEN AND REMOVING ANTIBIOTICS IN BIOLOGICAL TREATMENT OF LIVESTOCK WASTEWATER”, filed on Jun. 5, 2019, the disclosure of which is incorporated herein by reference in its entirely.

### FIELD OF INVENTION

The present invention relates to wastewater treatment, and more specifically, relates to a method for retaining ammonia nitrogen and removing antibiotics in the biological treatment of livestock wastewater.

### BACKGROUND OF INVENTION

The global livestock industry has expanded in recent years, thanks to the effective prevention and treatment of diseases and the promotion of animal growth by veterinary antibiotics themselves. For the purpose to reduce costs and increase production, livestock and poultry farming methods gradually changed from semi-intensive to high-density, large-scale and intensive, and the amount of veterinary antibiotics also increased substantially. It is reported that the use of veterinary antibiotics in China in 2015 has exceeded 100,000 tons, accounting for more than half of the global use of veterinary antibiotics. The effective utilization rate of antibiotics in the livestock and poultry industry is not high, 30% to 90% of the antibiotics used are still in the form of original drugs or their metabolites into the environment through excreta, a large part of which entered the surface water. Large amounts of antibiotics entering natural water bodies can damage their ecology, endanger aquatic life and even threaten drinking water safety. For example, increasing microbial resistance in the environment and enhancing bacterial immunity; inducing resistant strains of bacteria and reducing antibiotic resistance. Especially when antibiotic residues in drinking water sources reach high levels, it may even disrupt the balance of the human gastrointestinal tract flora. Therefore, in recent years, the issue of antibiotic residues and removal in natural water bodies has received widespread attention, the Yangtze River Delta and the Pearl River Delta and other developed regions have begun to explore how to control antibiotic pollution in the livestock and poultry breeding industry from the source.

At present, the manure of our livestock and poultry breeding industry is mostly used as compost. Sewage is properly treated and then used for land return or discharged after treatment up to standard. The livestock and poultry farming industry wastewater back to the field, not only can make full use of the nitrogen and phosphorus rich in it, reduce farmers' reliance on fertilizer, but also can solve the problem of high costs of sewage treatment and low pass rate of discharge. However, in the current reuse process of livestock and poultry farming wastewater (livestock and poultry farming wastewater→biogas digester→stabilization pond→return to field), antibiotics remaining in the wastewater will pollute groundwater or surface water through lysis or surface runoff. In addition, in the current reuse process of livestock and poultry farming wastewater, it is necessary to dilute the discharge of stabilization pond with river water to reduce the COD value less than 1000 mg/L, otherwise, seedlings would wilt. Diluting the discharge of stabilization pond with river water will inevitably increase the total amount of water to be irrigated, resulting in a high risk of environmental pollution, as the land used for manure removal in accordance with the principle of “sow-matching” cannot absorb all the wastewater.

Clearly, the key to reducing the amount of river water for diluting is to reduce COD concentrations in livestock and poultry farming wastewater. The biogas digester in the current reuse process of reusing livestock and poultry farming wastewater to field is equivalent to an anaerobic digester in the wastewater treatment processes, which can remove about 70% of the COD with proper operation and management, but the antibiotic removal effect is poor. To further reduce the COD of livestock and poultry farming wastewater, and to achieve a good antibiotic degradation, it is necessary to introduce an aerobic biological treatment unit. For example, livestock and poultry farms that implement the discharge of wastewater standards mostly use a combined process of anaerobic (facultative anaerobic)-aerobic and coagulation sedimentation to treat wastewater, so that concentrations of conventional pollutants (such as COD, ammonia nitrogen, total nitrogen and total phosphorus) in the effluent are in compliance with discharge standards. However, for the process of reusing livestock and poultry farming wastewater to field, the nitrogen and phosphorus in livestock and poultry farming wastewater should be retained as much as possible, otherwise there is no point in reusing.

As ammonia nitrogen is positively charged, it can be adsorbed by negatively charged soil colloid and is not easily lost. However, nitrous nitrogen is negatively charged and repels each other with the same negatively charged soil colloid and is easily lost. Therefore, for livestock farming wastewater reused to field, it is better to remain nitrogen in a form of ammonia nitrogen. However, in a normal aerobic biological treatment process of livestock and poultry farming wastewater, ammonia nitrogen can be converted into nitrate nitrogen, which is easily reduced to nitrogen in anoxic environment, causing nitrogen loss. Therefore, preventing the nitrification of ammonia nitrogen in an aerobic degradation process of COD is the key to reduce the amount of river water for diluting and retaining the value of reusing livestock and poultry farming wastewater to field.

On the other hand, from available literature reports, any system that achieves a high antibiotic removal rate during aerobic biological treatment of livestock and poultry breeding wastewater has a high sludge age of activated sludge, generally greater than 30 days (Zhen W, et al. Journal of Environmental Sciences, 2018, 65:8-17; Yang W, et al. Desalination, 2008, 231: 200-208). The operation of aerobic biological treatment systems at such a high sludge age (greater than or equal to 30 days) will inevitably lead to ammonia nitrogen nitrification, and even denitrification may occur inside the activated sludge, resulting in nitrogen loss.

Therefore, removal of antibiotics and retention of ammonia nitrogen in aerobic biochemical treatment is a pair of contradictions.

### SUMMARY OF INVENTION

The first purpose of the present invention is to provide a method for retaining ammonia nitrogen and removing antibiotics in biological treatment of livestock wastewater that inhibits nitrifying bacterial activity without affecting heterotrophic bacterial activity.

In order to achieve the first purpose of the present invention, a method for retaining ammonia nitrogen and removing antibiotics in biological treatment of livestock wastewater is provided, wherein the activity of nitrifying bacteria is inhibited by adding a nitrification inhibitor into an aerobic bioreactor with a sludge age greater than or equal to 30 days.

In a preferred embodiment, said nitrification inhibitor is 2-chloro-6-(trichloromethyl)pyridine (CAS No. 1929-82-4), allylthiourea (CAS No. 109-57-9), 3,4-dimethylpyrazole phosphate (CAS No. 202842-98-6), or dicyanodiamide (CAS No. 461-58- 5).

In a preferred embodiment, the dosage of 2-chloro-6-(trichloromethyl)pyridine in the aerobic bioreactors is in a range from 1.5 to 5.0 mg/g VSS·d.

In a preferred embodiment, the dosage of allylthiourea in the aerobic bioreactors is in a range from 10 to 30 mg/g VSS·d.

In a preferred embodiment, an anaerobic biological treatment is employed before the aerobic biological treatment performed by said aerobic bioreactor to remove COD.

In a preferred embodiment, the anaerobic biological treatment is performed by a conventional UASB reactor with a hydraulic residence time (HRT) of 2 to 10 days, a sludge concentration (MLSS) of 10 to 40 g/L, and a pH value of 7.0 to 8.5.

In a preferred embodiment, the aerobic biological treatment is performed by said aerobic bioreactor with a hydraulic residence time (HRT) of 3 to 6 days, a sludge concentration (MLSS) of 3000 to 6000 mg/L, a pH value of 6.5 to 8.5, and a dissolved oxygen concentration (DO) of 1.0 to 6.0 mg/L.

In the present invention, the occurrence of ammonia nitrogen nitrification is inhibited without sacrificing the degradation of COD and antibiotics by heterotrophic bacteria by adding a chemical agent capable of inhibiting the activity of nitrifying bacteria into the aerobic biological treatment unit for treating livestock and poultry farming wastewater, so that the aims of retaining ammonia nitrogen while removing antibiotics are realized.

### DESCRIPTION OF DRAWINGS

The FIGURE is a diagram of the anaerobic-aerobic biochemical treatment process of the livestock wastewater in accordance with the present invention.

### DETAILED DESCRIPTION OF PREFERRED EMBODIMENTS

The present invention is further illustrated combining with specific implements below. The experimental methods used in the following implements are conventional methods unless otherwise specified. The materials, reagents and the like used in the following implements are commercially available unless otherwise specified. It shall be understood that the implements are used only to illustrate the present invention but not to limit its scope.

### Example 1

Wastewater from a pig farm in Jinshan District, Shanghai is treated by the anaerobic-aerobic biochemical treatment process of the present invention, which is shown in the FIGURE.

In the FIGURE, operation conditions of the UASB reactor, the aerobic tank A and the aerobic tank B are listed.

(1) UASB Reactor

Hydraulic residence time (HRT): 3 days;
Sludge concentration (MLSS): 15±1 g/L; and,
pH value: 7.5±0.5.

(2) Aerobic Tank A

Hydraulic residence time (HRT): 3 days;
Sludge residence time (SRT): 40 days;
Sludge concentration (MLSS): 4500±500 mg/L;
pH value: 8.0±0.5; and,
Dissolved oxygen concentration (DO): 3.0±0.5 mg/L.

(3) Aerobic Tank B

Hydraulic residence time (HRT): 3 days;
Sludge residence time (SRT): 40 days;
Sludge concentration (MLSS): 4500±500 mg/L;
pH value: 8.0±0.5;
Dissolved oxygen concentration (DO): 3.0±0.5 mg/L; and,
Dosage of 2-chloro-6-(trichloromethyl)pyridine: 3.0 mg/g VSS·d.

The average COD concentration of the influent is 5610 mg/L and the average ammonia nitrogen concentration of the influent is 835 mg/L. After the operation of the anaerobicaerobic biochemical treatment system shown in the FIGURE is stable, the effluent of the secondary sedimentation tank A has an average COD concentration of 247 mg/L and an average ammonia nitrogen concentration of 7.3 mg/L. As a consequence, in a case that no 2-chloro-6-(trichloromethyl)pyridine is added into the aeration tank, the removal rate of COD is about 95.6% in average, and the removal (or nitrification) rate of ammonia nitrogen is about 99.1% in average. Meanwhile, the effluent of the secondary sedimentation tank B has an average COD concentration of 355 mg/L and an average ammonia nitrogen concentration of 731 mg/L. As a consequence, in a case that 2-chloro-6-(trichloromethyl)pyridine is added into the aeration tank, the removal rate of COD is about 93.7% in average, and the removal (or nitrification) rate of ammonia nitrogen is about 12.5% in average.

It comes to a conclusion that adding an appropriate amount of 2-chloro-6-(trichloromethyl)pyridine into the aeration tank can effectively inhibit the nitrification of ammonia nitrogen without sacrificing the degradation of COD, so that the COD concentration of the effluent meets the requirements of reusing to field.

Moreover, after the operation of the anaerobic-aerobic biochemical treatment system shown in the FIGURE is stable, the concentrations of two main antibiotics, sulfonamides and β-lactams, in the influent, the effluents of the secondary sedimentation tank A and secondary sedimentation tank B are respectively determined by HPLC-MS/MS, so as to calculate the total concentration and total removal rate of these two major antibiotics. The result shows that the total concentration of these two major antibiotics of the influent is 323.1 μg/L in average, the total concentration of these two major antibiotics of the effluent of the secondary sedimentation tank A is 23.6 μg/L in average, and the total concentration of these two major antibiotics of the effluent of the secondary sedimentation tank B is 31.0 μg/L in average.

As a consequence, the removal rate of antibiotics is about 92.7% in average in a case that no 2-chloro-6-(trichloromethyl)pyridine is added into the aeration tank, while the removal rate of antibiotics is about 90.4% in average in the case of adding 2-chloro-6-(trichloromethyl)pyridine into the aeration tank. The removal rates in these two cases are not much different.

It comes to a conclusion that adding an appropriate amount of 2-chloro-6-(trichloromethyl)pyridine into the aeration tank may has little effect on removing antibiotics from the anaerobic-aerobic biochemical treatment system.

In conclusion, the occurrence of ammonia nitrogen nitrification is inhibited by adding 2-chloro-6-(trichloromethyl)pyridine capable of inhibiting the activity of nitrifying bacteria into the aeration tank, without sacrificing the degradation of COD and antibiotics.

### Example 2

The wastewater source, treatment process and operating conditions in this Example are the same as those in Example 1. The only difference is that the 2-chloro-6-(trichloromethyl)pyridine added into the aeration Tank B in Example 1 is replaced by allylthiourea, which is added at 15 mg/g VSS d.

The average COD concentration of the influent is 5382 mg/L and the average ammonia nitrogen concentration of the influent is 792 mg/L. After the operation of the anaerobicaerobic biochemical treatment system shown in the FIGURE is stable, the effluent of the secondary sedimentation tank A has an average COD concentration of 286 mg/L and an average ammonia nitrogen concentration of 10.3 mg/L. As a consequence, in a case that no allylthiourea is added into the aeration tank, the removal rate of COD is about 94.6% in average, and the removal rate of ammonia nitrogen is about 98.7% in average. Meanwhile, the effluent of the secondary sedimentation tank B has an average COD concentration of 430 mg/L and an average ammonia nitrogen concentration of 652 mg/L. As a consequence, in a case that allylthiourea is added into the aeration tank, the removal rate of COD is about 92.0% in average, and the removal (or nitrification) rate of ammonia nitrogen is about 17.7% in average.

It comes to a conclusion that adding an appropriate amount of allylthiourea into the aeration tank can effectively inhibit the nitrification of ammonia nitrogen without sacrificing the degradation of COD, so that the COD concentration of the effluent meets the requirements of reusing to field.

Moreover, after the operation of the anaerobic-aerobic biochemical treatment system shown in the FIGURE is stable, the concentrations of two main antibiotics, sulfonamides and β-lactams, in the influent, the effluents of the secondary sedimentation tank A and secondary sedimentation tank B are respectively determined by HPLC-MS/MS, so as to calculate the total concentration and total removal rate of these two major antibiotics. The result shows that the total concentration of these two major antibiotics of the influent is 284.5 μg/L in average, the total concentration of these two major antibiotics of the effluent of the secondary sedimentation tank A is 23.2 μg/L in average, and the total concentration of these two major antibiotics of the effluent of the secondary sedimentation tank B is 34.5 μg/L in average.

As a consequence, the removal rate of antibiotics is about 91.8% in average in a case that no allylthiourea is added into the aeration tank, while the removal rate of antibiotics is about 87.8% in average in the case of adding allylthiourea into the aeration tank. The removal rates in these two cases are not much different.

It comes to a conclusion that adding an appropriate amount of allylthiourea into the aeration tank may has little effect on removing antibiotics from the anaerobic-aerobic biochemical treatment system.

In conclusion, the occurrence of ammonia nitrogen nitrification is inhibited by adding allylthiourea capable of inhibiting the activity of nitrifying bacteria into the aeration tank, without sacrificing the degradation of COD and antibiotics.

The above descriptions are only the preferred schemes of the present invention, and it should be noted that for ordinary technicians in the technical field, without departing from the principles of the present invention, some improvements and polishing can also be made, and these improvements and polishing should also be considered as the scope of protection of the present invention.

What is claimed is:

1. A method for retaining ammonia nitrogen and removing antibiotics in biological treatment of livestock wastewater, wherein a nitrification inhibitor is added into an aerobic bioreactor with a sludge age greater than or equal to 30 days to inhibit the activity of nitrifying bacteria.

2. The method for retaining ammonia nitrogen and removing antibiotics in biological treatment of livestock wastewater as claimed in claim 1, wherein said nitrification inhibitor is 2-chloro-6-(trichloromethyl)pyridine, allylthiourea, 3,4-dimethylpyrazole phosphate, or dicyanamide.

3. The method for retaining ammonia nitrogen and removing antibiotics in biological treatment of livestock wastewater as claimed in claim 2, wherein the dosage of 2-chloro-6-(trichloromethyl)pyridine in the aerobic bioreactors is in a range from 1.5 to 5.0 mg/g VSS·d.

4. The method for retaining ammonia nitrogen and removing antibiotics in biological treatment of livestock wastewater as claimed in claim 2, wherein the dosage of allylthiourea in the aerobic bioreactors is in a range from 10 to 30 mg/g VSS·d.

5. The method for retaining ammonia nitrogen and removing antibiotics in biological treatment of livestock wastewater as claimed in claim 1, wherein an anaerobic biological treatment is employed before an aerobic biological treatment performed by said aerobic bioreactor to remove COD.

6. The method for retaining ammonia nitrogen and removing antibiotics in biological treatment of livestock wastewater as claimed in claim 5, wherein said anaerobic biological treatment is performed by a conventional UASB reactor with a hydraulic residence time of 2 to 10 days, a sludge concentration of 10 to 40 g/L, and a pH value of 7.0 to 8.5.

7. The method for retaining ammonia nitrogen and removing antibiotics in biological treatment of livestock wastewater as claimed in claim 1, wherein an aerobic biological treatment is performed by said aerobic biological treatment with a hydraulic residence time of 3 to 6 days, a sludge concentration of 3000 to 6000 mg/L, a pH value of 6.5 to 8.5, and a dissolved oxygen concentration of 1.0 to 6.0 mg/L.
